(19) United States
(12) Patent Application Publication
(10) Pub. No.: US 2023/0066037 A1
(43) Pub. Date: Mar. 2, 2023

(54) CONTROLLED DOSING CONTAINER AND METHODS OF USING THE SAME

(71) Applicants: Chloe Casturo-Burnette, Greenwich, CT (US); Isabella Hall, Greenwich, CT (US); Sarina Kulsakdinun, Armonk, NY (US)

(72) Inventors: Chloe Casturo-Burnette, Greenwich, CT (US); Isabella Hall, Greenwich, CT (US); Sarina Kulsakdinun, Armonk, NY (US)

(21) Appl. No.: 17/841,298

(22) Filed: Jun. 15, 2022

Related U.S. Application Data
(60) Provisional application No. 63/236,979, filed on Aug. 25, 2021.

(51) Int. Cl. B65D 83/04

(52) U.S. Cl. CPC B65D 83/0445

(57) ABSTRACT

A controlled dosing container can include a container body having an interior volume. The interior volume can be divided into individual dosing volumes sized to receive a unit dose by a divider. The container can further include a rotatable inner cap fixed to the container body. The rotatable inner cap can have an opening sized to allow a unit dose to be dispensed there-through and adapted to rotate such that the opening is aligned sequentially with each dosing volume on a fixed dosing schedule.

### CROSS-REFERNCE TO RELATED APPLICATIONS

This application claims the benefit of priority to U.S. Provisional Patent Application No. 63/236,979 filed Aug. 25, 2021, the disclosure of which is incorporated herein by reference in its entirety.

### BACKGROUND

In 2017 the U.S. Government declared the opioid epidemic a public health emergency after recognizing the widespread abuse and misuse of opioids. Opioids are a class of highly addictive drugs resulting from the drug's ability to bind to receptors in the brain to block dopamine-inhibitory transmitter and promote the release of dopamine. In 2019, there were approximately 71,000 drug overdose deaths, with over 70% involving opioids. Abuse and misuse of highly addictive and/or dangerous drugs, like opioids, are widespread, with over 3,900 people abusing opioids daily. Patients with no previous exposure to narcotics can be at particularly high risk for misuse that could ultimately result in death. A standard opioid prescription generally includes 30 pills; a quantity sufficient to lead to overdose and possible death. Misuse can result from patients unintentionally taking the wrong dose, dosing too close together, or from intentional misuse.

### SUMMARY

Controlled dosing of such dangerous drugs at the consumer level is needed to help combat the misuse, whether intentional or unintentional. Controlled dosing containers disclosed herein can ensure patients take the proper dosage amount on the proper dosing schedule. This can avoid misuse and reduce the likelihood of a patient becoming addicted to the drug. Containers of the disclosure can also be used with non-additive drugs and other pharmaceutical or nutraceutical products, for example, to facilitate a patient's adherence to a proper dosing amount and/or dosing schedule. This can be particularly useful in elderly patients or other patient populations who may have difficulty in remembering a dosing schedule and/or dosing amount.

### BRIEF DESCRIPTION OF THE DRAWINGS

FIG. 1 is a top view of a controlled dosing container;

FIG. 2 is a side view of a controlled dosing container showing pills contained therein;

FIG. 3 is a side view of a controlled dosing container showing the container empty;

FIG. 4 is a cut-away side view of a container of the disclosure;

FIG. 5 is a top view of an exterior cap with a counter; and

FIG. 6 is a side view of a container having a counter.

### DETAILED DESCRIPTION

A controlled dosing container can include a container body having an interior volume defined therein to receive one or more unit doses (such as a pill), a divider disposed in the interior volume for dividing the interior volume into two or more dosing volumes, and a rotatable inner cap attached to the container body. The container can further include a removable exterior cap that seals over the internal cap, for example, for storage. Each dosing volume can be adapted to contain a single dose or unit dose of a medication or other pharmaceutical or nutraceutical product to be taken by the user. A unit dose can include one or more pills, tablets, sachets, pouches, granules, powders, capsules, including liquid and gel capsules, liquids, suspensions, gels, pellets, and other known unit dosage forms. A unit dose can include multiples of a dosage form, such as two or more pills, tablets, capsules, and the like or could include a single one of the dosage forms containing the entire unit dose amount. For ease ofreference, the term “pills” will be used herein, but it should be understood that the containers of the disclosure are adapted to contain any desired unit dosage form. Use of the containers with both solid and liquid dosage forms are contemplated herein

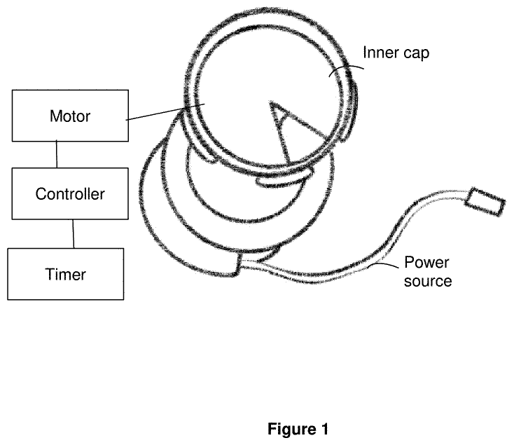

Referring to FIG. 1, the rotatable inner cap is adapted to rotate automatically on a fixed time interval and contains an opening that exposes a given dosing volume upon rotation. In embodiments, the rotatable inner cap can be permanently fixed to the container body, such that the interior volume cannot be accessed, except through the opening in the inner cap, once the inner cap is fixed onto the container body without destruction or damage to the container. In other embodiments, the inner cap can be removably fixed to the container body, which can allow for the refilling of the container. In embodiments in which the container is for use with a controlled substance, the inner cap can be locked onto the container body. The lock can be adapted only for removal by a pharmacist or other medical professional. In embodiments, the lock can be a child-resistant lock and/or patient resistant. In embodiments, the lock can be tamper-evident, showing visible signs of attempts to open the lock.

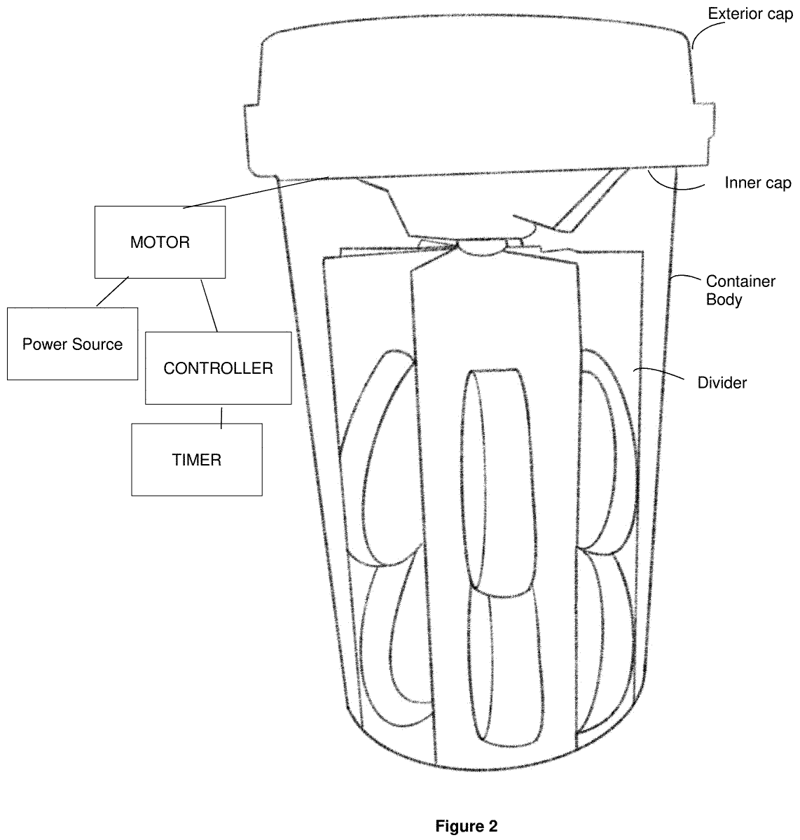

The rotation of the inner cap can be powered by any suitable motor. The motor can be contained within the inner cap entirely and/or include components that are disposed away from but electrically connected to the inner cap or a motor provided thereon. FIG. 2 illustrates the motor generally in block form only. The location of the motor and power source can depend on the size of the container for example. The power source for the motor can be any suitable power source, including, but not limited to battery power. The container can be rechargeable and can include a charge port disposed in any location of the container, for example, as generally illustrated in block form in FIG. 2.

In embodiments in which the container is adapted to contain a liquid dosage form, the inner cap can be sealed to the container body with a leak-resistant seal to prevent leakage of the liquid dosage form. The opening can also include a seal such that the entire container can be sealed between doses, and the opening can be exposed in the correct dosing location at the dosing time. Alternatively, the container can include an exterior cap that is adapted to provide a liquid tight seal when the container is in storage or otherwise not be used for dosing of the liquid. Any liquid tight sealing methods known in the art can be used, such as inclusion of O-rings.

The opening is sized such that only the unit dose from the dosing volume over which the opening is disposed can be dispensed through the opening. The container can include a programmable timer and a control system for receiving information from the programmable timer and controlling the rotatable inner cap to rotate on the fixed time interval programmed into the timer. The programmable timer can be tamper resistant, such that only a pharmacist, medical professional, or other authorized individual can program the timer. In embodiments, a consumer can program the timer and the timer can be lockable such that once programmed, the timer cannot be reprogrammed without, for example, inputting of a code or otherwise resetting the system. The container can be adapted to rotate the opening of the inner cap to expose successive dosing volumes at a fixed time. The fixed time generally corresponds to the dosing schedule for the medication or nutraceutical contained in the container.

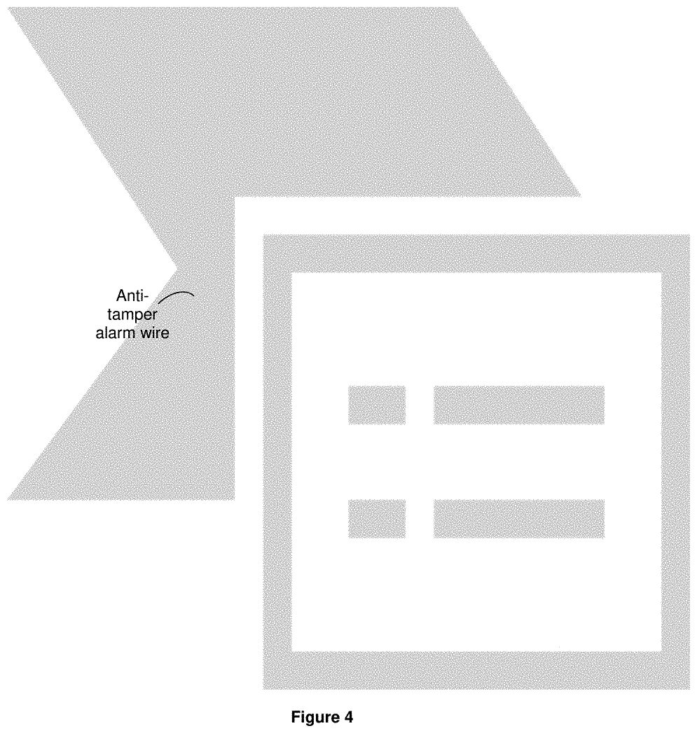

Referring to FIG. 4, the container can further include an exterior cap that closes on or seals to the container body, covering the inner cap. The exterior cap can be useful, for example, for storage, to cover the opening in the inner cap when the container is not in use. The motor can include or can be electrically connected to a controller, which in turn communicates with the timer for controlling the rotation of the inner cap on the desired dosing schedule.

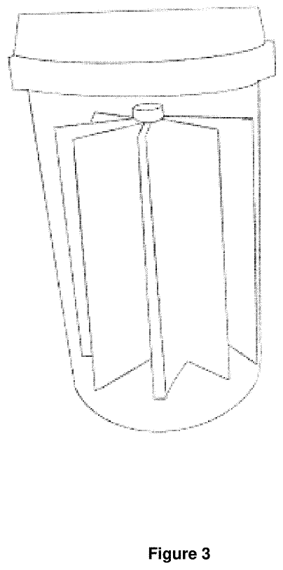

Referring to FIGS. 2 and 3, in embodiments, the divider can include one or more vertical dividing portions that divide the internal volume into two or more dosing volumes. Each dosing volume can be sized to hold a unit dose of the medication or other substance to be contained. The divider with its one or more vertical dividing portions can divide the internal volume into any suitable number of dosing volumes. The number of dosing volumes can be determined, for example, based on a total number of doses to be contained in a container before requiring a refill of the container.

In further embodiments, the divider can include one or more vertical dividing portions and one or more horizontal dividing portions. The one or more horizontal dividing portions can divide the internal volume into two or more dosing levels, while the vertical dividing portions can divide the internal volume into dosing volumes within each dosing level. This can advantageously allow for an increased number of dosing volumes to be included in the container by having multiple dosing volumes on each dosing level within the container. The one or more horizontal dividing portions can be arranged such that all or only part of the horizontal dividing portion can be removed or otherwise shifted to allow for access to the dosing level below the horizontal dividing portion. For example, the horizontal dividing portion can include two rotating portions, each comprising an opening. The two rotating portions can be adapted to rotate such that neither opening exposes a dosing volume of the dosing level below the horizontal dividing portion and then is further rotatable to align the openings to expose a dosing volume of the dosing level disposed below the horizontal dividing portion. The aligned openings can then be further configured to rotate together to allow for dosing from the dosing volumes in this newly exposed dosing level. For example, the openings can be configured once aligned to rotate with the rotation of the opening in the inner cap to allow for removal of the unit dose from the exposed dosing volume. Any suitable means for aligning the openings to expose the dosing level beneath the horizontal divider can be used. For example, the horizontal divider rotating portions can be connected to a timer and control system that initiates rotation of one or both of the rotating portions into alignment after a certain elapse of time corresponding to administration of the dosing volumes from the dosing level arranged above the horizontal divider portion. Other suitable means of accessing the dosing level arranged below a horizontal divider portion are contemplated herein. For example, the horizontal divider portion can include hinged elements with hinges that can be triggered to release either manually or automatically to drop the hinged element to create an opening through which the dosing volume of the desired dosing level can be exposed. For example, the horizontal divider can be composed of a plurality of movable flaps that can shift between a first position in which the flap covers a dosing volume and a second position in which the flap shifts away from and exposes the dosing volume. For example, the flaps can be hinged elements.

In embodiments, the dosing container can include an alarm to alert the patient of a dosing time. The alarm can be an audible alarm and/or a visual alarm.

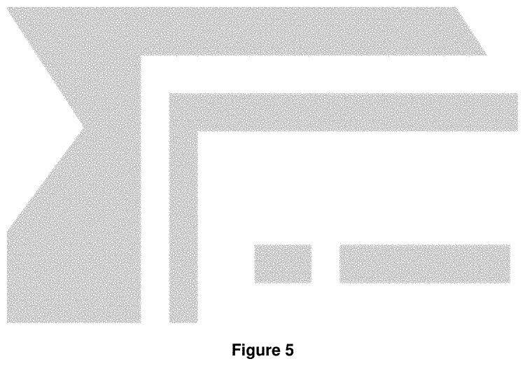

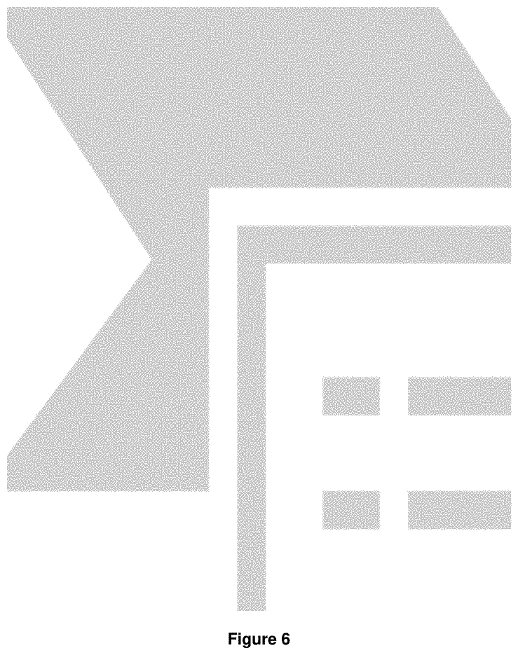

Referring to FIGS. 5 and 6, other visual displays can be included on or connected to the dosing container. For example, the dosing container can have a counter to display the total doses remaining. For example, the counter can be a photoelectric counter and have a visual display electrically connected thereto to display the number of unit doses remaining in the container body. The visual display can be disposed on the container body and/or the interior cap and/or the exterior cap, if present. In other embodiments, the container can be adapted to transmit a signal to a stand-alone visual display such as cell phone, for example, through an app-based connection.

In embodiments, the container can include an anti-tamper alarm. The anti-tamper alarm can signal when an improper attempt is made to remove the inner cap or unlock a lock on the container. The anti-tamper alarm can be, for example, an audible alarm and/or can send a signal to a relevant party, such as a doctor, pharmacist or other caregiver indicating an attempt to tamper with the device.

For example, the anti-tamper alarm can include a sensor disposed in or on the inner cap. The sensor can be adapted to detect attempts for removal or improper rotation of the inner cap and send an alarm and/or trigger the neutralizing release apparatus. Referring to FIG. 4, the alarm can include a wire disposed in the container body and connected to the inner cap to sense tamper with or removal of the inner cap from the container body and/or destruction of the container body. In the embodiment shown in FIG. 4, the container body can include a double wall structure, with the wire disposed between the double walls.

The container can further or alternatively include a neutralizer release apparatus that is adapted to release a neutralizing agent to deactivate the unit doses. The neutralizer release can be adapted to release the neutralizing agent automatically, for example, in the event of detected tampering. The neutralizer release apparatus can also or alternatively be adapted to be manually or remotely activated to release the neutralizing agent. For example, in the event remaining unit doses are no longer needed and must be disposed of, the neutralizing agent can be released to inactivate the unit doses for safe disposal. In other embodiments, remote activated release can be useful when an anti-tamper alarm is sent as a signal to a relevant party, who can then investigate and trigger release if tampering is confirmed. Any suitable neutralizing agent can be used. For example, the neutralizing agent can be a carbon-based deactivation system.

In any of the embodiments herein, the container body, dividers, inner cap, and/or exterior cap (when present) can be made of a rigid plastic material. The rigid plastic can be polyolefin. For example, the polyolefin can be one or more of polypropylene, polyethylene, polyethylene terephthalate, polystyrene, polyvinyl chloride, laminates thereof, blends thereof, and combinations thereof. Use of other materials, such as glass containers, are also contemplated herein.

The technical information set out herein may in some respects go beyond the disclosure of the invention, which is defined exclusively by the appended claims. The additional technical information is provided to place the actual invention in a broader technical context and to illustrate possible related technical developments. Such additional technical information which does not fall within the scope of the appended claims, is not part of the invention.

While particular embodiments of the present invention have been shown and described in detail, it will be obvious to those skilled in the art that changes and modifications may be made without departing from the invention in its broader aspects. Therefore, the aim is to cover all such changes and modifications as fall within the true spirit and scope of the invention. The matters set forth in the foregoing description and accompanying drawings are offered by way of illustration only and not as limitations. The actual scope of the invention is to be defined by the subsequent claims when viewed in their proper perspective based on the prior art.

What is claimed:

1. A controlled dosing container, comprising:
container body having an internal volume defined therein;
a divider disposed in the internal volume for dividing the internal volume into dosing volumes, each dosing volume sized to receive a unit dose;
a rotatable inner cap fixed to the container body, the rotatable inner cap having an opening sized to allow the unit doses to be dispensed there through, the rotatable inner cap being adapted to rotate such that the opening is alignable with each dosing volume to allow for dispensing of the unit doses from only the aligned dosing volume;
a programmable timer for receiving as an input a fixed time interval; and
a control system electrically connected to the programmable timer and the rotatable inner cap, wherein the control system receives an input from the programmable time and is adapted to automatically rotate the inner cap to expose a dosing volume at the fixed time interval.

2. The controlled dosing container of claim 1, wherein the rotatable inner cap is permanently fixed to the container body.

3. The controlled dosing container of claim 1, wherein the divider comprises a vertical dividing portion and a horizontal dividing portion, wherein the vertical dividing portion divides the internal volume into dosing volumes and the horizontal dividing portion divides the internal volume in to dosing levels.

4. The controlled dosing container of claim 3, wherein the vertical dividing portion comprises vertical dividers disposed in each dosing level, such that each dosing level is further divided into dosing volumes.

5. The controlled dosing container of claim 4, wherein the divider comprises one horizontal dividing portion to divide the internal volume into two dosing levels.

6. The controlled dosing container of claim 3, wherein the horizontal dividing portion comprises two rotating portions, each comprising an opening, wherein the two rotating portions are adapted to rotate such that neither opening exposes a dosing volume of the dosing level disposed below the horizontal dividing portion and further rotatable to align the openings to expose a dosing volume of the dosing level disposed below the horizontal dividing portion.

7. The controlled dosing container of claim 3, wherein the horizontal dividing portion is adapted to shift between a first position in which a dosing level disposed below the horizontal dividing portion is covered by the horizontal dividing portion and a second position in which the horizontal dividing portion exposes at least a portion of the dosing level disposed below the horizontal dividing portion.

8. The controlled dosing container of claim 3, wherein the horizontal dividing portion comprises a plurality of movable flaps, each dosing volume comprising at least one of the plurality of movable flaps to divide the dosing volume into at least two dosing levels, wherein each of the movable flaps is adapted to shift between first and second positions, wherein when in the first position the movable flap covers a dosing level disposed below the movable flap and in the second position the dosing level disposed below the movable flap is exposed.

9. The controlled dosing container of claim 1, wherein the inner cap is adapted to lock onto the container body.

10. The controlled dosing container of claim 9, wherein the lock is child-resistant.

11. The controlled dosing container of claim 1, further comprising an alarm to alert the patient of a dosing time.

12. The controlled dosing container of claim 1, further comprising a photoelectric counter and visual display electrically connected to the counter to display the number of unit doses remaining in the container body.

13. The controlled dosing container of claim 12, wherein the visual display is disposed on the container body or on the inner cap.

14. The controlled dosing container of claim 1, further comprising an anti-tamper alarm and/or neutralizer release apparatus adapted to release a neutralizing agent to deactivate the unit doses if tampering is detected.

15. The controlled dosing container of claim 14, wherein the container comprises the anti-tamper alarm and the anti-tamper alarm comprises a sensor disposed in the inner cap.

16. The controlled dosing container of claim 17, wherein the sensor is adapted to activate the neutralizer release apparatus if the inner cap is removed from the container body or if the inner cap is forcibly rotated.

17. The controlled dosing container of claim 16, wherein the container comprises the neutralizer release apparatus.

18. The controlled dosing container of claim 16, wherein the neutralizer release agent is carbon-based deactivation system.

19. The controlled dosing container of claim 1, wherein the container body is made of a rigid plastic.

20. The controlled dosing container of claim 1, further comprising an exterior cap adapted to connect to or seal to the container body and cover the inner cap.
